(19) United States
(12) Patent Application Publication
(10) Pub. No.: US 2010/0326041 A1
(43) Pub. Date: Dec. 30, 2010

(54) HEATED GUIDE VANE

(76) Inventor: Wayne Garcia Edmondson, West Chester, OH (US)

Correspondence Address: GENERAL ELECTRIC COMPANY, GE AVIATION, ONE NEUMANN WAY MD F16, CINCINNATI, OH, 45215, US

(21) Appl. No.: 12/495,287

(22) Filed: Jun. 30, 2009

(51) Int. Cl. F02C 7/047; F04D 29/54; F01D 25/02; F01D 25/10; F01D 25/14

(52) U.S. Cl. 60/39.093; 415/208.1; 415/114; 415/178

(57) ABSTRACT

A heated guide vane for turbomachinery includes a guide vane having two major surfaces joined about their periphery by edges and an electric heater element, wherein the electric heater element is secured to at least one major surface of the guide vane.

### STATEMENT REGARDING FEDERALLY SPONSORED RESEARCH & DEVELOPMENT

The US Government may have certain rights in this invention pursuant to Contract No. SFX awarded by the US Department of the Air Force.

### BACKGROUND OF THE INVENTION

The technology described herein relates generally to turbomachinery, particularly to gas turbine engines, and more particularly, to a heated guide vane for gas turbine engines.

Many gas turbine engine assemblies include a fan assembly that is mounted upstream from a core gas turbine engine. During operation, a portion of the airflow discharged from the fan assembly is channeled downstream to the core gas turbine engine wherein the airflow is further compressed. The compressed airflow is then channeled into a combustor, mixed with fuel, and ignited to generate hot combustion gases. The combustion gases are then channeled to a turbine, which extracts energy from the combustion gases for powering the compressor, as well as producing useful work to propel an aircraft in flight. The other portion of the airflow discharged from the fan assembly exits the engine through a fan stream nozzle.

To facilitate channeling the airflow into the fan assembly, some known gas turbine engine assemblies includes an inlet guide vane assembly that is used to direct the air in a desirable orientation toward the fan blades. Inlet guide vanes (IVGs) may be provided in either a fixed orientation or may be constructed in a variable inlet guide vane configuration. Variable inlet guide vanes (VIGVs) may be adjusted for various operating conditions and environments, often by pivoting the guide vanes about an axis, to achieve the desired airflow characteristics leading into the fan assembly. In addition to turning the fan airflow, the inlet guide vane assembly may also provide structural stiffness to the fan frame. More specifically, inlet guide vane assemblies generally include a plurality of inlet guide vanes that are coupled to the fan frame.

Inlet guide vane assemblies, along with other structural elements of aircraft and aircraft engines, may be susceptible of forming ice accumulation under certain operating and environmental conditions. Ice accumulation on such structures, besides adding weight to the structures, often has a detrimental effect on performance through alteration of the surface texture and structural shape of the element undergoing ice accumulation.

Various approaches to addressing ice accumulation have been developed, including the use of heated air supplied from a source such as a warmer pressurized source within the engine itself. However, there remains a need for an improved guide vane heater to effectively and efficiently address ice accumulation.

### BRIEF SUMMARY OF THE INVENTION

In one aspect, a heated guide vane for turbomachinery includes a guide vane having two major surfaces joined about their periphery by edges and an electric heater element, wherein the electric heater element is secured to at least one major surface of the guide vane.

In another aspect, a gas turbine engine having a central axis of rotation and a defined direction of rotation about the axis includes a core gas turbine engine, a fan assembly disposed upstream from the core gas turbine engine including a plurality of fan blades, and at least one heated guide vane associated with the fan blades. The heated guide vane includes a guide vane having two major surfaces joined about their periphery by edges and an electric heater element, wherein the electric heater element is secured to at least one major surface of the guide vane.

### BRIEF DESCRIPTION OF THE DRAWINGS

FIG. 1 is a cross-sectional illustration of an exemplary gas turbine engine assembly;

FIG. 2 is an elevational view of an inlet guide vane suitable for use in the gas turbine engine assembly shown in FIG. 1;

FIG. 3 is an exploded perspective view of the guide vane of FIG. 2 illustrating the relationship of the vane to the heater mesh element;

FIG. 4 is a perspective view of the inlet guide vane of FIG. 3;

FIG. 5 is an exploded perspective view of another embodiment of a guide vane suitable for use in the gas turbine engine assembly of FIG. 2; and

FIG. 6 is a perspective view of the inlet guide vane of FIG. 5.

### DETAILED DESCRIPTION OF THE INVENTION

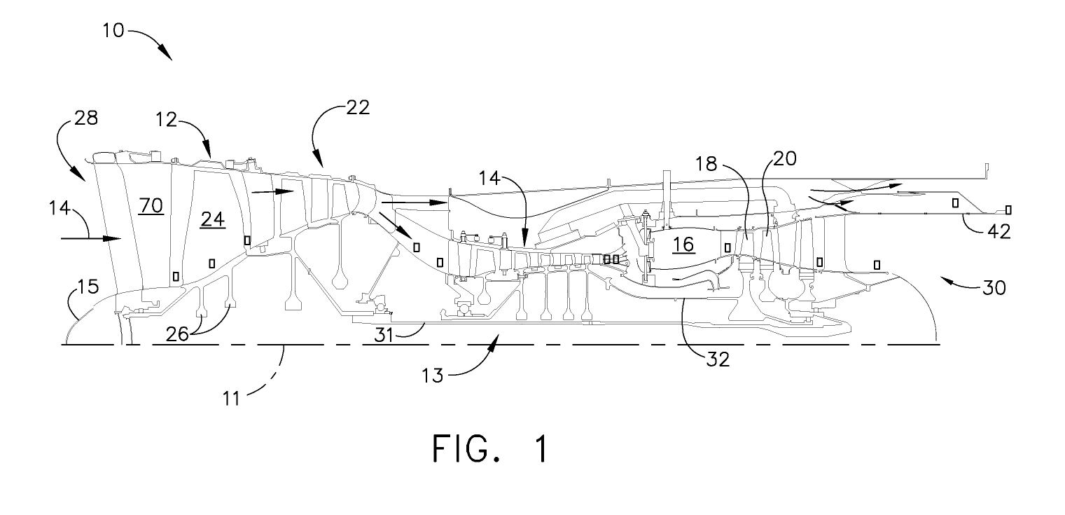

FIG. 1 is a cross-sectional schematic illustration of an exemplary gas turbine engine assembly 10 having a longitudinal axis 11. Gas turbine engine assembly 10 includes a fan assembly 12 and a core gas turbine engine 13. Core gas turbine engine 13 includes a high pressure compressor 14, a combustor 16, and a high pressure turbine 18. In the exemplary embodiment, gas turbine engine assembly 10 also includes a low pressure turbine 20, and a multi-stage booster compressor 22.

Fan assembly 12 includes an array of fan blades 24 extending radially outward from a rotor disk 26. Gas turbine engine assembly 10 has an intake or inlet side 28 and an exhaust side 30. Fan assembly 12, booster 22, and turbine 20 are coupled together by a first rotor shaft 31, and compressor 14 and turbine 18 are coupled together by a second rotor shaft 32.

In operation, air flows through fan assembly 12 and booster 22. The compressed air that is discharged from booster 22 is channeled through compressor 14 wherein the airflow is further compressed and delivered to combustor 16. Hot products of combustion (not shown in FIG. 1) from combustor 16 are utilized to drive turbines 18 and 20 before being exhausted through an exhaust duct 42, and turbine 20 is utilized to drive fan assembly 12 and booster 22 by way of shaft 31. Gas turbine engine assembly 10 is operable at a range of operating conditions between design operating conditions and off-design operating conditions.

A plurality of inlet guide vanes 70 that typically extend substantially radially, between a radially-outer mounting flange and a radially-inner mounting flange, and are circumferentially-spaced around inlet 28, guide incoming airflow 14 into the fan assembly 12. Inlet guide vanes 70 serve to turn the airflow upstream from rotating blades such as fan blades 24 for aerodynamic purposes to achieve the desired airflow characteristics into and through the fan assembly 12 under various operating conditions. Outlet guide vanes (shown but not numbered in FIG. 1), supporting struts, and other structures may be provided upstream and/or downstream of the fan blades 24 for structural or aerodynamic purposes.

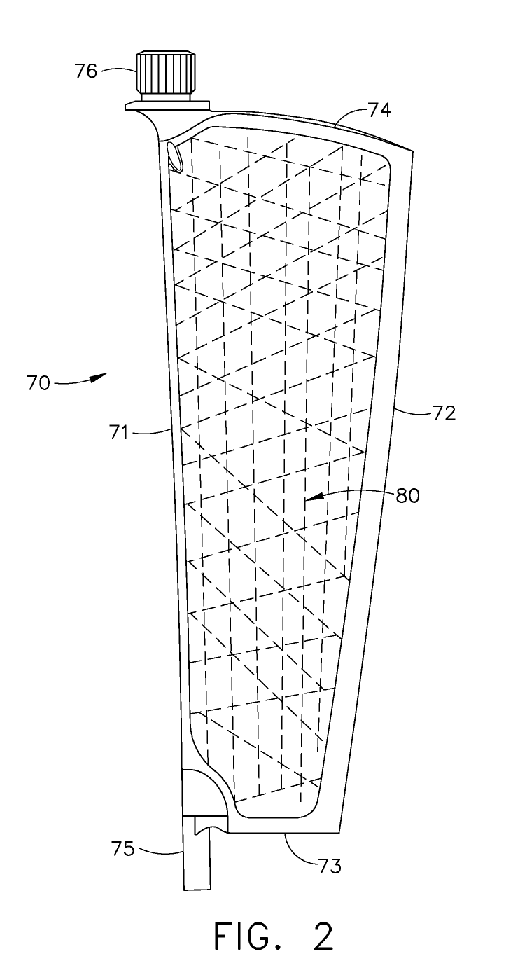

FIG. 2 is an elevational view of an inlet guide vane 70 suitable for use in the gas turbine engine 10 of FIG. 1. Guide vane 70 has a leading edge 71, a trailing edge 72, an inner edge 73, and an outer edge 74. Guide vane 70, in the embodiment shown, is an airfoil-shaped structure which has two major surfaces joined about their periphery by edges 71-74. Guide vane 70 is secured in place by suitable mounting features such as inner and outer mountings 75 and 76, respectively. Mounting features such as inner and outer mountings 75 and 76 may provide for adjustment of the orientation of guide vane 70 on a one-time or continuous basis, or may maintain it in a fixed position relative to the gas turbine engine 10.

As shown in FIG. 2, the inlet guide vane 70 also includes a heater element 80 mounted on a major surface thereof. Heater element 80 is electrically powered and is connected to a suitable electrical power source through suitable electrical connections (not shown for illustrative clarity). The heater element 80 converts electrical energy into heat energy, which may then be transferred to accumulated ice overlying the heater element or adjoining surfaces of the inlet guide vane 70 which receive heat from the heater element 80.

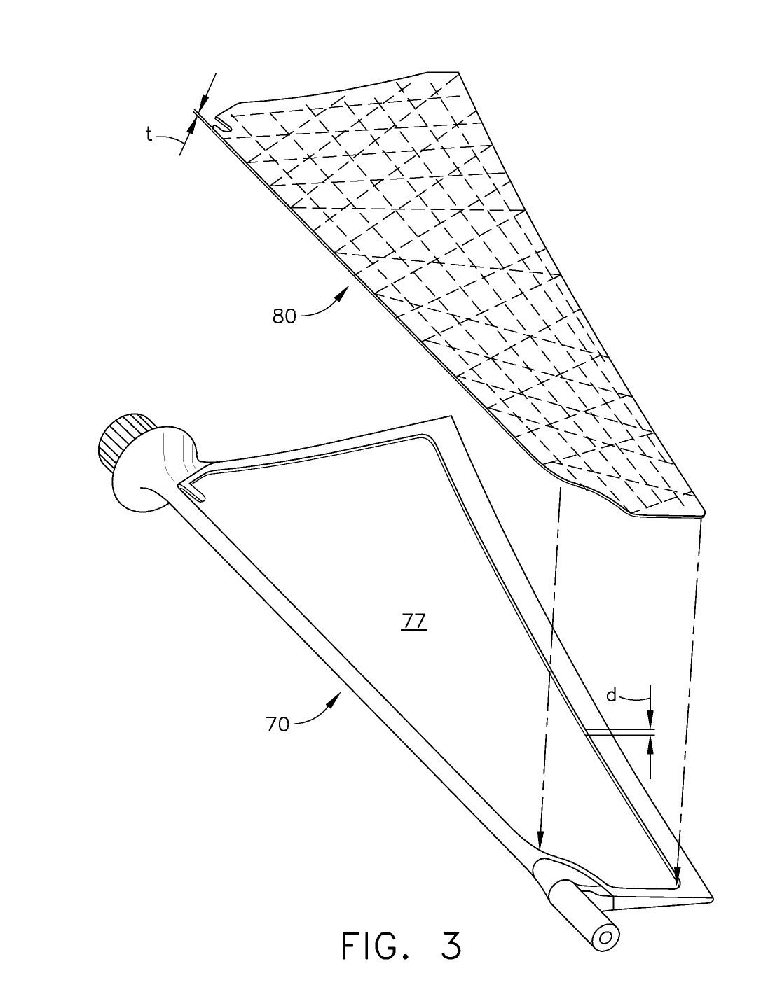

FIG. 3 shows in greater detail the relationship of heater element 80 to inlet guide vane 70. To accommodate the installation of heater element 80, the inlet guide vane 70 includes a recess 77 suitably sized and shaped to receive the heater element 80 while maintaining the desired aerodynamic profile of inlet guide vane 70. To permit a substantially flush installation, where the heater element 80 is substantially flush with the outer surface profile of a major surface of the inlet guide vane 70, the recess is constructed at a depth “d” which correlates to a thickness “t” of the heater element 80, plus any additional localized or generalized dimension needed for adhesive or other mounting features (not shown) to secure the heater element 80 in place in recess 77. By way of example, a recess depth of 0.030 inches may be utilized to accommodate a heater element plus its bonding agent.

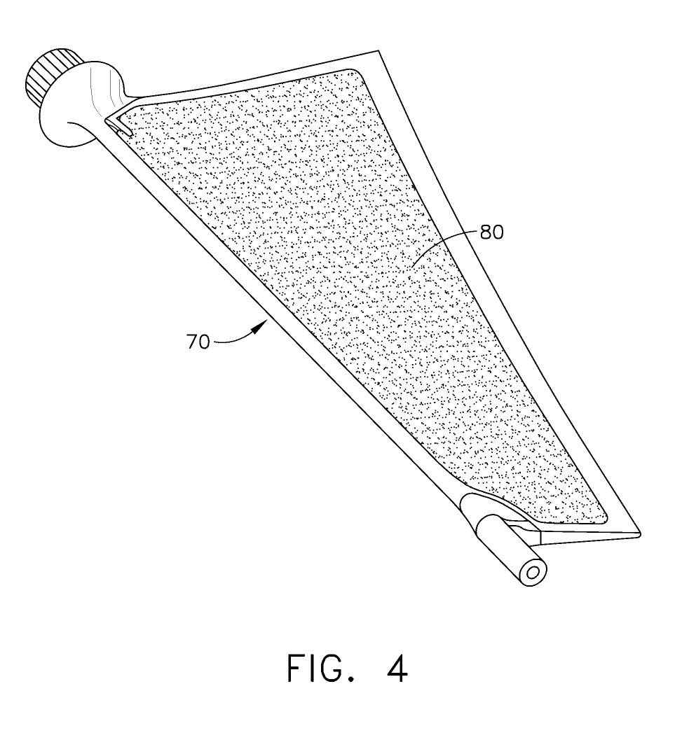

Heater element 80 is suitably sized and shaped, and configured to deliver sufficient heating value, to provide the desired anti-ice-accumulation benefit to inlet guide vane 70 under various operating conditions. In the embodiment shown in FIG. 3, the heater element 80 covers a substantial portion of one major surface of inlet guide vane 70. FIG. 4 illustrates the fully-assembled inlet guide vane 70 with the heater element 80 installed.

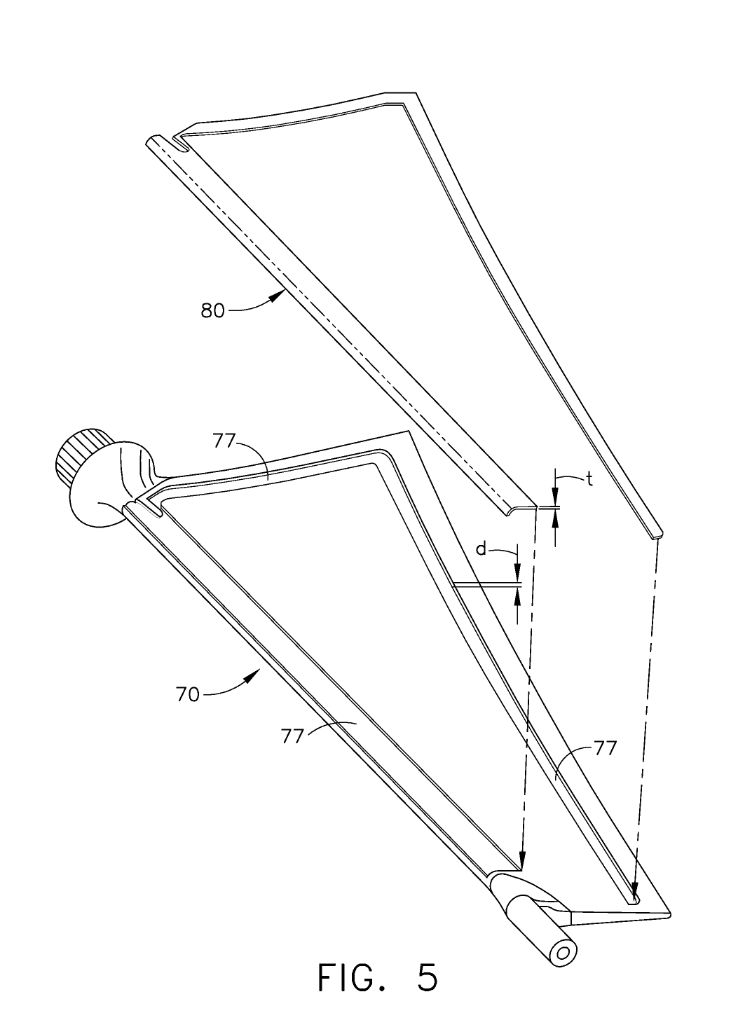

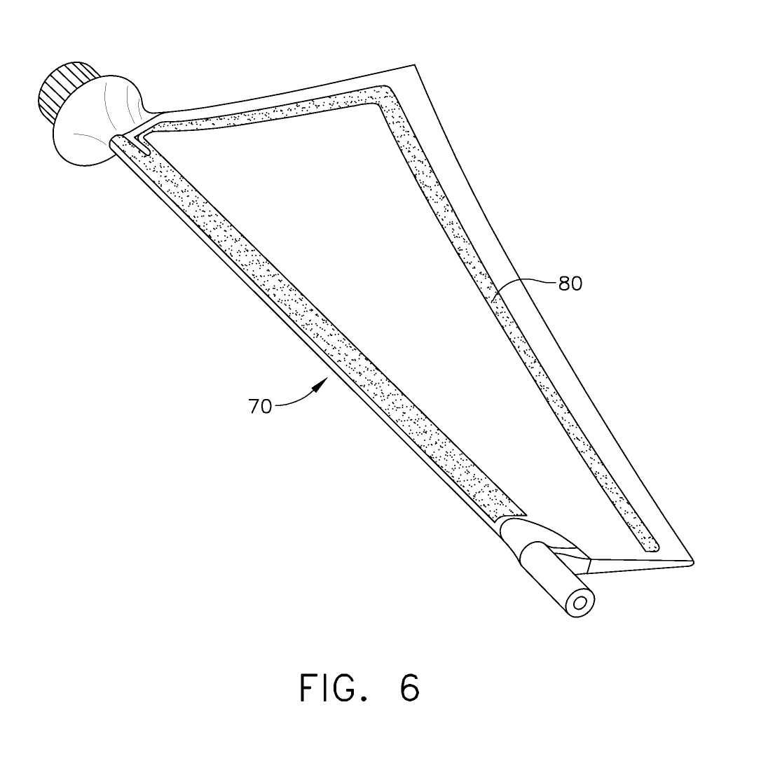

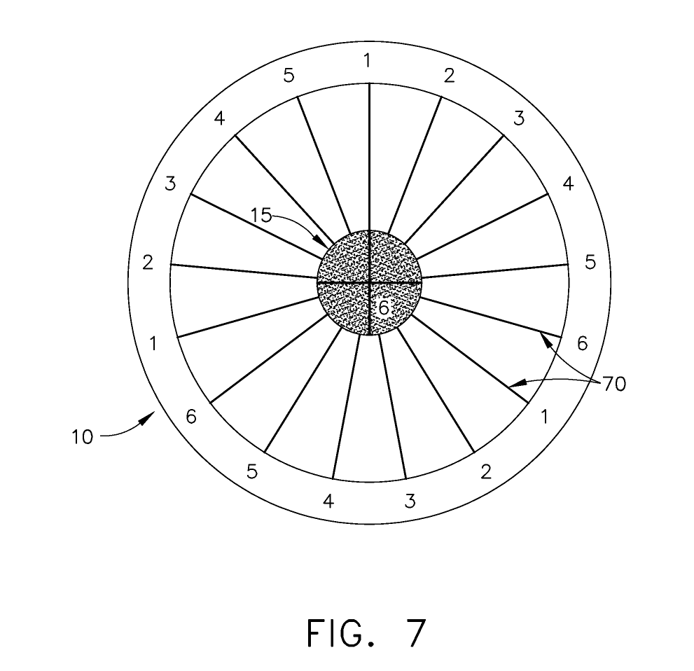

FIGS. 5 and 6 depict another embodiment of a heated guide vane 70. In this embodiment, the heater element 80 takes the form of an elongated strip which is sized, shaped, and adapted to be secured to a correspondingly sized and shaped recess 77 which follows the periphery of a major surface of the guide vane 70. This configuration focuses the heat generated by the heater element in a specific region of the guide vane 70 rather than heating the entire guide vane generally through a continuous heater element as in the embodiment of FIGS. 2-4, which covers a majority of a major surface of the guide vane 70. As in the previous embodiment, FIG. 5 illustrates the depth “d” of recess 77 and the thickness “t” of the heater element 80. The “picture frame” or peripheral configuration concentrates the heat around the periphery of the guide vane, namely edges 71-74 shown in FIG. 2. This may result in more effective distribution of generated heat and hence smaller heater element area coverage with reduced power requirements.

FIG. 7 is an elevational view illustrating, looking rearward from the front of the gas turbine engine, the relationship of the vanes 70 to the reference lines and axes of the gas turbine engine 10. As shown in FIG. 3, the guide vanes 70 are circumferentially distributed around the central axis 11 of the gas turbine engine 10. Numerical identifiers 1 through 6 are used to identify groups of guide vanes 70 which are under common control so as to be selectively energized or de-energized together.

In the configuration shown, seventeen guide vanes 70 plus the nose cone 15 are included in the control scheme. By way of example, the three guide vanes identified with the numeral 1 may be energized while the remaining guide vanes 70 and the shaded areas 6 of nose cone 15 are de-energized. The guide vanes 70 identified with the numeral 1 may then be de-energized and the guide vanes 70 identified with the numeral 2 may energized. In such an exemplary configuration, a pattern of energizing and de-energizing guide vanes 70 may be established to maintain the desired performance while managing electrical power consumption at a lower level than were all guide vanes 70 with comparable power outputs simultaneously energized. In the embodiment shown, sequential sets of 3 guide vanes numbered as zones 1 through 5 are energized for their duty cycle and then turned off, then zone 6 with the two remaining guide vanes 70 and the shaded areas 6 of nose cone 15 are energized and then de-energized. The cycle may then be repeated beginning again with zone 1 as many times as desired.

Individual guide vanes 70 or groups of guide vanes 70 under common control may be energized in various patterns or sequences as desired. The respective time periods for energization and de-energization may also be determined as necessary to obtain the desired performance. Such an operating scheme may also be called a “duty cycle” and may be measured in terms of time on in comparison with time off and/or in terms of the periodic nature of the cycle (interval between repetitive events). An exemplary duty cycle for illustration purposes only may be 10 seconds on and 50 seconds off, in which case the energizing time period is shorter than the de-energizing time period for a given heater element. In such a configuration, with 6 zones illustrated in FIG. 7, each zone is energized for 10 seconds until all 6 zones have been heated in turn, after which the cycle repeats itself with the overall periodicity being 1 minute between successive complete cycles. By sizing all zones to have at least somewhat similar power requirements, a somewhat consistent level of power demand can be obtained.

Other elements may be heated in conjunction or combination with guide vanes 70, such as struts, nose cones, etc., and may be heated concurrently or on a different heating scheme. For example, some elements may have a longer duty or heating cycle, or may be set to heat continuously, while other elements cycle on and off. In the embodiment shown in FIG. 7, the “X” in the center of the nose cone 15 may remain energized to serve an anti-icing function (to discourage ice formation in that region) while the other heating zones operate periodically to shed accumulated ice.

The guide vanes 70 may be fabricated from any suitable materials using any suitable fabrication methods as are known in the art and suitable for the intended configuration and operating environment. Configuration details, such as the number, thickness, and geometry of guide vanes 70, may be determined and implemented to achieve the desired operating and performance characteristics of the turbomachinery in which they are installed. Metallic materials such as Titanium and Titanium alloys may be utilized, alone or in combination with other non-metallic materials. Guide vanes 70 may be unitarily formed or assembled from individual components, and may be solid elements or may be hollow structures with interior spaces empty or filled with lightweight materials.

Heater elements 80 may be fabricated from any suitable materials or components as required for the desired heat output and operating environment. Nickel or other conductive materials may be fashioned into a mesh, grid, or other electrically conductive network and generate heat through electrical resistance or other operating modality. The heat output and power input may be suitably tailored on a power-per-square-inch basis or other suitable criteria. Power output densities of, for example only, 32 W/square inch or 35 W/square inch, may be utilized.

The control system for the heated guide vanes 70 may be located, constructed, and programmed to operate in any manner suitable for the intended physical and operating environment. Additionally, under some operating conditions it may be desirable to design and operate the heating system to break up and shed ice after some period of accumulation (but while still relatively thin and breakable into small pieces) rather than melting ice and generating liquid water which would pass farther through the engine assembly and potentially re-freeze later. Power to operate the heater elements may be provided by a power source such as a generator, powered by the gas turbine engine associated with the heater elements or not so associated, or by any other suitable power supply.

While much of the discussion has focused on an aviation gas turbine engine as the context for the heated guide vanes, it is foreseeable that such heater installations may be suitable for use in other environments wherein a guide vane associated with rotating turbomachinery, such as wind or steam turbines.

While the invention has been described in terms of various specific embodiments, those skilled in the art will recognize that the invention can be practiced with modification within the spirit and scope of the claims.

What is claimed is:

1. A heated guide vane for turbomachinery, said heated guide vane comprising:
a guide vane having two major surfaces joined about their periphery by edges; and
an electric heater element;
wherein said electric heater element is secured to at least one major surface of said guide vane.

2. A heated guide vane in accordance with claim 1, wherein said guide vane is an inlet guide vane.

3. A heated guide vane in accordance with claim 1, wherein said guide vane has a recess on a major surface thereof, and wherein said heater element is mounted in said recess.

4. A heated guide vane in accordance with claim 3, wherein said heater element is mounted substantially flush with said surface.

5. A heated guide vane in accordance with claim 1, wherein said heater element is a continuous mat and is secured within said recess so as to substantially cover said surface.

6. A heated guide vane in accordance with claim 1, wherein said heater element is an elongated strip and is secured within said recess so as to cover a peripheral region of said surface.

7. A heated guide vane in accordance with claim 1, wherein said guide vane is movable.

8. A heated guide vane in accordance with claim 1, wherein said guide vane is a variable inlet guide vane.

9. A heated guide vane in accordance with claim 1, wherein said heater element is bonded to said guide vane.

10. A heated guide vane assembly for turbomachinery, said heated guide vane assembly comprising:
a plurality of guide vanes having two major surfaces joined about their periphery by edges; and
at least one electric heater element;
wherein at least one of said guide vanes has an electric heater element secured to at least one major surface of said at least one guide vane.

11. A heated guide vane assembly in accordance with claim 10, wherein said plurality of guide vanes are arranged radially around a centerline of said turbomachinery.

12. A heated guide vane assembly in accordance with claim 10, wherein a plurality of said guide vanes have an electric heater element secured to at least one major surface of said guide vanes.

13. A heated guide vane assembly in accordance with claim 10, further comprising a control system to selectively energize and de-energize said at least one heater element.

14. A heated guide vane assembly in accordance with claim 13, wherein said control system is operable on a periodic cycle to selectively energize and de-energize said at least one heater element.

15. A heated guide vane assembly in accordance with claim 13, wherein said control system is operable to selectively energize at least one heater element and substantially simultaneously selectively de-energize at least one heater element.

16. A heated guide vane assembly in accordance with claim 15, wherein said control system is operable to selectively energize a plurality of heater elements symmetrically arranged around a centerline of said turbomachinery.

17. A heated guide vane assembly in accordance with claim 16, wherein said control system is operable to selectively energize a plurality of heater elements symmetrically arranged around a centerline of said turbomachinery and selectively de-energize said plurality of heater elements sequentially in a pattern which advances around said centerline.

18. A heated guide vane assembly in accordance with claim 13, wherein said control system is operable to energize and de-energize said at least one heater element for specific time intervals.

19. A heated guide vane assembly in accordance with claim 15, wherein said guide vane has a recess on a major surface thereof, and wherein said heater element is mounted in said recess.

20. A gas turbine engine, said gas turbine engine having a central axis of rotation and a defined direction of rotation about said axis, said gas turbine engine comprising:
a core gas turbine engine;
a fan assembly disposed upstream from said core gas turbine engine, said fan assembly comprising a plurality of fan blades; and
at least one heated guide vane associated with said fan blades, said heated guide vane comprising:
a guide vane having two major surfaces joined about their periphery by edges; and
an electric heater element;
wherein said electric heater element is secured to at least one major surface of said guide vane.
